(19) United States
(12) Patent Application Publication
(10) Pub. No.: US 2019/0156263 A1
(43) Pub. Date: May 23, 2019

(54) WORKPLACE EVALUATION VIA ANALYTICS

(71) Applicant: COLLABOGENCE INC., Toronto (CA)

(72) Inventors: Peter Christian SMIT, Toronto (CA); Jeffrey William KISCHUK, Toronto (CA); Matthew Alfons LOHBIHLER, Markham (CA)

(21) Appl. No.: 16/198,830

(22) Filed: Nov. 22, 2018

Related U.S. Application Data
(60) Provisional application No. 62/590,050, filed on Nov. 22, 2017.

(51) Int. Cl. G06Q 10/06

(52) U.S. Cl. CPC G06Q 10/06393; G06Q 10/06313

(57) ABSTRACT

An example of an apparatus to improve productivity at an organization is provided. The apparatus includes a communication interface to receive processed data collected at the organization, wherein the processed data is based on data from a plurality of data sources. In addition, the apparatus includes a memory storage unit to store the processed data. Furthermore, the apparatus includes an analysis engine in communication with the memory storage unit. The analysis engine is to analyze the processed data to determine a collaboration index value between a first individual at the organization and a second individual at the organization. The apparatus also includes an optimization engine to generate a layout plan based on the collaboration index value. Example of a method and computer readable medium are also provided.

### FIELD

The present disclosure relates to data collection and more specifically to automated data collection.

### BACKGROUND

Organizations typically require a large number of individuals or workers to interact with each other in a collaborative manner in order to function efficiently. The efficiency of the organization as a whole depends on the interactions between each of the individuals with other individuals. For example, individuals in an accounting department of the organization may need to communicate with each other as well as other individuals of the organization in order to accomplish their tasks, such as reconciling expenses, preparing reports, etc.

The placement of individuals of an organization is typically optimized by the use of consultants or other experts. Accordingly, the placements are open to the subjective bias of the individuals making the decisions.

### DESCRIPTION OF THE DRAWINGS

Reference will now be made, by way of example only, to the accompanying drawings in which:

FIG. 1 is a diagram of a system in accordance to an embodiment of the invention;

FIG. 2 is a block diagram of an apparatus of the system shown in FIG. 1;

FIG. 3 is a block diagram of another apparatus of the system shown in FIG. 1;

FIG. 4 is a flowchart of a method in accordance with an embodiment;

FIG. 5 is a flowchart of a method in accordance with another embodiment; and

FIG. 6 is a flowchart of a method in accordance with another embodiment.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

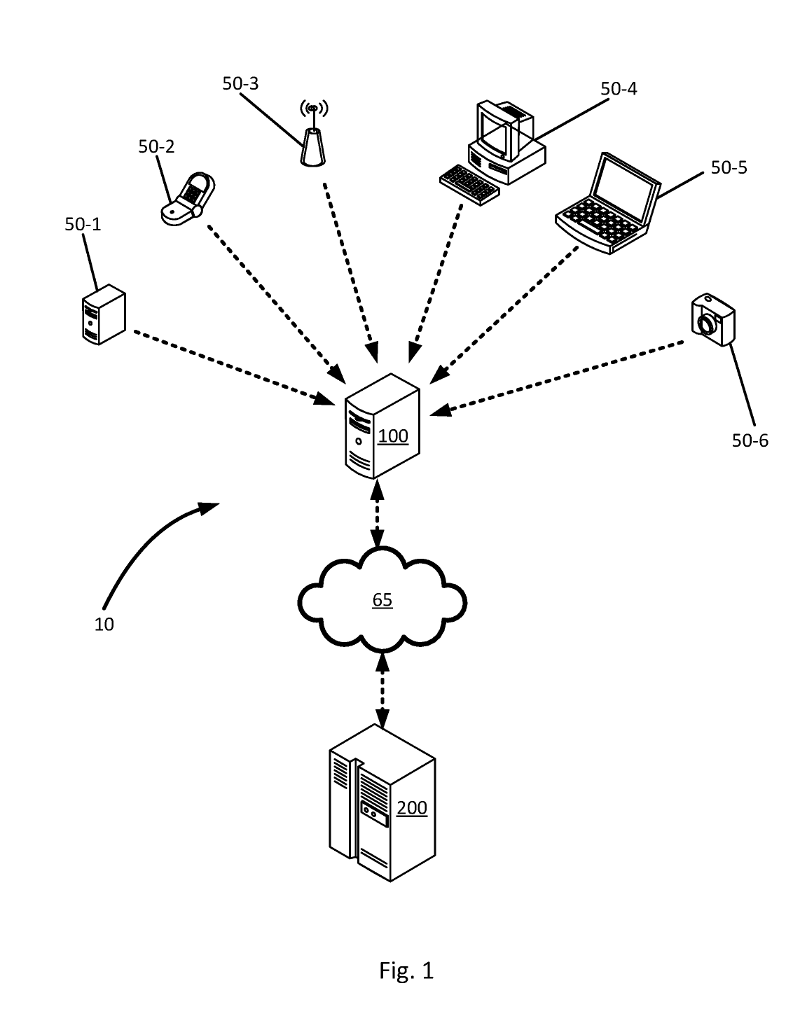

Referring to FIG. 1, a schematic representation of a system for collecting data to optimize productivity in an organization is shown at 10. It is to be understood that the system is purely exemplary and it will be apparent to those skilled in the art that a variety of systems and substitutions are contemplated. The system 10 includes a plurality of data sources 50-1, 50-2, 50-3, 50-4, 50-5 and 50-6 (generically, data source 50, and collectively data sources 50. This nomenclature is used elsewhere herein). In addition, the system 10 includes a local apparatus 100, such as a server or other computing device, and a central apparatus 200, such as a server or other computing device, communicating with each other over a network 65. The network 65 is not particularly limited and can include any type of network such as the Internet, an intranet or a local area network, or a mobile network. In some embodiments, the network 65 may also include a peer to peer network.

The plurality of data sources 50 are generally configured to collect raw data. The manner by which each of the plurality of data sources 50 collects data is not particularly limited. In addition, the exact type of data collected is not particularly limited. For example, the data collected may be metadata or actual data. In the present embodiment, the data source 50-1 may be an email apparatus storing a plurality of email messages, which may be the raw data, in communication with the local apparatus 100. In this example, the raw data may include the contents of email messages as well as information to identify senders and recipients of the email and other relevant information in an email message. Furthermore, it is to be understood that each data source 50 is not necessarily a separate device. For example, a single device such as a desktop computer may provide multiple data sources 50 by providing raw data from multiple applications, such as an email application, an instant messaging application, a web-conferencing application, a voice communication application, a social media application, a customer-relationship management application, a project management application, and other applications on the desktop computer. It is to be appreciated by a person of skill in the art with the benefit of this description that the local apparatus 100 may then process the raw data prior to sending the processed data for analysis externally. For example, portions of the data file may be omitted for various reasons, such as reducing the size of the stored raw data or to comply with a data management policy. In other embodiments, the removal of some identifying information can occur during a de-identification procedure on the local apparatus 100 as discussed in greater detail below.

The data source 50-2 may be a portable device, such as a mobile phone, tablet, smartphone, or other device used within an organization. In the present embodiment, the data source 50-2 is generally associated with a specific user since the user typically keeps the portable device on the person at all times. Accordingly, the data source 50-2 may provide a good indication of the location of the user. For example, the data source 50-2 may be configured to collect location data through a global positioning system (GPS), or WIFI network locator, such as using a reverse IP lookup to determine where an individual is. In addition, the data source 50-2 may be capable of collecting additional information pertaining to user activity using various sensors, such as motion sensors, cameras, and speakers. The data source 50-2 may also log device activity such as phone call information and/or data usage. The raw data collected by the data source 50-2 may be sent to the local apparatus 100 for additional processing.

The data source 50-3 may be a location sensor. For example, the data source 50-3 may be part of a radio-frequency identification (RFID) tracking system to monitor the user as the user passes through various locations. For example, the data source 50-3 may be positioned in a room of a building and collect real time information about the occupants of the room within range if the data source 50-3. In other embodiments, the data source 50-3 may be a WIFI hotspot configured to log devices that are within range. The devices entering the range of the WIFI hotspot may then be associated with specific user via a device specific identifier, such as a media access control address.

As another example, the data source 50-4 may be a personal computer. The raw data collected by the data source 50-4 is not particularly limited and may include interactions a user typically has with the data source 50-4 that may be recorded in log files. For example, the data source 50-4 may track the amount of time spent by a user operating the personal computer to provide an indication of the amount of time spent at a location. In addition, the activities carried out by the user can provide data such as the amount of time the user spends on each activity. For example, the time spent browsing the internet or typing in a word processor or email program can be tracked. Periods of inactivity at the data source 50-4 may indicate that the user has moved away from the personal computer, such as for a break or to another location to interact with another individual of the organization.

The data source 50-5 may be a laptop device, which may offer similar functionality as a personal computer. It is to be appreciated by a person of skill in the art that the difference between a personal computer and a laptop device is primarily in the portability that the laptop device may offer. For example, the data source 50-4 may be typical of a traditional office environment, whereas the data source 50-5 may be more typical of an organization where individuals do not have permanent desks and instead are often “hoteling”. Due to the more mobile nature of the data source 50-5, the raw data transmitted to the local apparatus 100 may include additional information such as location and movement tracking as well as user activity at a specific location. For example, the data may show that an email client is often accessed in a break room, while spreadsheets are accessed in a private office.

The data source 50-6 may be a camera or other monitoring system, such as a motion sensor. The data source 50-6 can collect raw data associated with the amount of user activity in a location, such as the number of users in a room during a period of time. In some embodiments, image recognition software, such as facial recognition, may be included to identify the individuals to provide additional data.

In general terms, the plurality of data sources 50 are configured to collect raw data from a physical location. The specific data is not limited and may include any data that can be suggestive of the use of a given physical location. For example, the raw data may track how the physical location is being used by specific individuals as well as groups of individuals. The raw data may provide information such as peak use times and other metrics. In this regard, raw data may include email data, instant messaging data, telephone data, web-conferencing data, social/community data, repository data, project management suite data, customer relationship management system data, and selected building system data such as reservations, sensor networks, badging and wireless network data. Other sources of data may include employee passcard data, communication program data (e.g. voice over IP data), and human resources data, such as employee lists, organization charts, seating plans, etc.

Furthermore, it is to be appreciated by a person of skill in the art with the benefit of this description that the raw data from each of the data sources 50 may overlap with another data source from the plurality of data sources 50. For example, raw data collected from the data source 50-1 may involve email logs, calendar appointments, and other similar communications received from a user that was initially entered at a personal computer. Accordingly, the raw data from the data source 50-4 may provide an email log and calendar appointments that were included in the raw data of the data source 50-1.

Although the present embodiment shown in FIG. 1 illustrates six data sources 50, it is to be appreciated that the number of data sources 50 is not limited and that more or less data sources are possible. For example, with the increase in popularity of smart buildings, additional data sources 50 may be possible, such as from access control points, etc. Similarly, the system 10 can be modified to use fewer data sources 50 to simplify the system such that the demands on the resources of the local apparatus 100 is reduced.

In a present embodiment, the local apparatus 100 can be any type of computing device generally configured to send, receive or process data. A vast array of types of computing environments for the local apparatus 100 is within the scope of the invention. For example, the local apparatus 100 may be a physical machine in a location configured to handle data in a secure manner. It is to be appreciated that the raw data collected by the data sources may be confidential and sensitive information. Accordingly, the local apparatus 100 may be a blade server having one or more processors, or may refer to a plurality of blade servers mounted on a rack operating together. In other embodiments, the local apparatus 100 may be a more basic device, such as personal computer or laptop computer for smaller systems where computational requirements are not as high as other systems. Furthermore, in other embodiments, the local apparatus 100 can also be implemented as a virtual apparatus, a rented apparatus session in the cloud, or any combination of the above

Similar to the local apparatus 100, the central apparatus 200 can be any type of computing device generally configured to send, receive or process data. In the present embodiment, the central apparatus 200 may be substantially identical to the computing environment as the local apparatus 100. In other embodiments, the central apparatus 200 may be different from the local apparatus 100. For example, the central apparatus 200 may be configured to communicate with multiple local servers and be part of several systems. It is to be emphasized that the present embodiment is a non-limiting embodiment only and that the local apparatus 100 and the central apparatus 200 can each be modified.

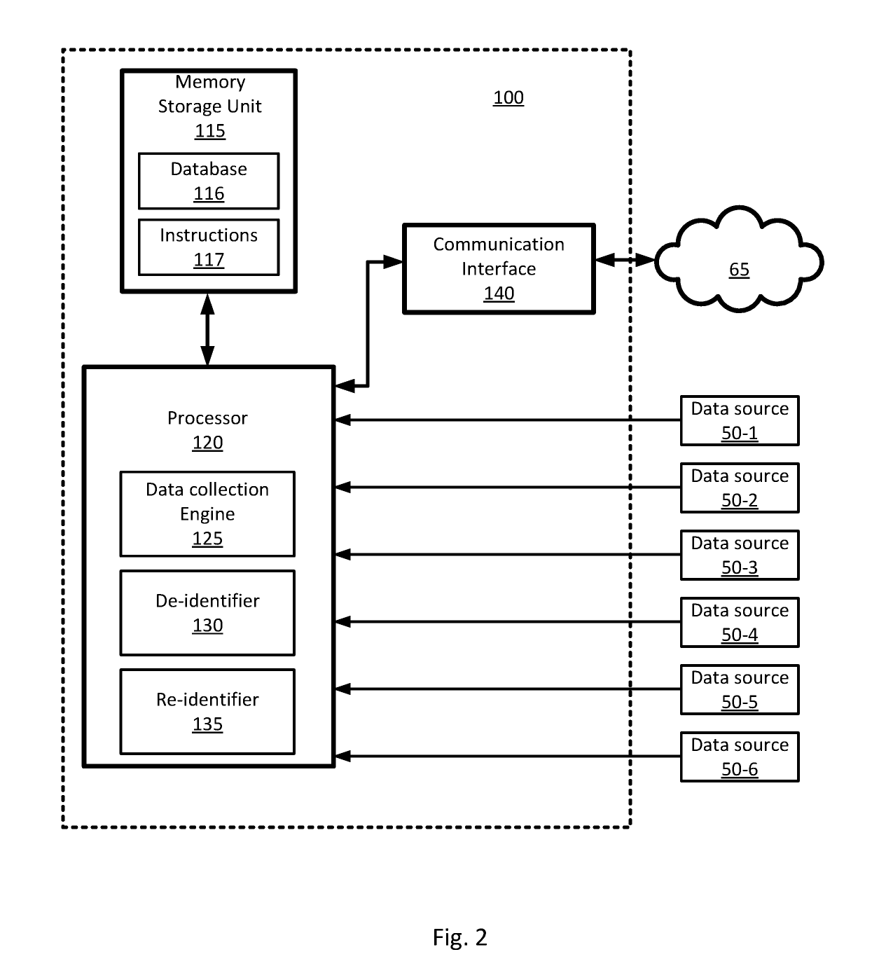

Referring to FIG. 2, a schematic diagram of components of the local apparatus 100 is shown in greater detail. It is to be appreciated by a person of skill in the art with the benefit of this description that the local apparatus 100 may include additional components, such as various additional interfaces and/or displays and input devices to interact with a user or additional processors to handle higher demand for resources. In the present embodiment, the local apparatus 100 includes a memory storage unit 115, a processor 120, and a communication interface 140.

The memory storage unit 115 is coupled to the processor 120 and may include a non-transitory machine-readable storage medium that may be any electronic, magnetic, optical, or other physical storage device. In the present example, the memory storage unit 115 is configured to store a database 116 and instructions 117. The database 116 is for storing various data handled by the local apparatus 100. For example, the database 116 may be configured to receive and store the raw data from the data sources 50. The memory storage unit 115 may also store executable instructions 117 for carrying out functions on the local apparatus 100 described in greater detail below.

The non-transitory machine-readable storage medium may include, for example, random access memory (RAM), electrically-erasable programmable read-only memory (EEPROM), flash memory, a storage drive, an optical disc, and the like. The machine-readable storage medium may be encoded with executable instructions to operate the local apparatus 100 and/or the data sources 50 in some embodiments.

The memory storage unit 115 may also store an operating system that is executable by the processor 120 to provide general functionality to the local apparatus 100, for example, functionality to support various applications such as a user interface to access various features of the local apparatus 100. Examples of operating systems include Windows™, macOS™, iOS™ Android™, Linux™, and Unix™. The memory storage unit 115 may additionally store applications that are executable by the processor 120 to provide specific functionality, such as communicating with the data sources 50.

The processor 120 may include a central processing unit (CPU), a microcontroller, a microprocessor, a processing core, a field-programmable gate array (FPGA), or similar. The processor 120 and memory storage unit 115 cooperate to execute instructions 117. In the present embodiment, the processor 120 carries out various functions such as the data collection engine 125, a de-identification engine 130, and a re-identification engine 135. The processor 120 may also be configured to operate as a web apparatus to render dashboards, alarms, and other features. In addition, the processor 120 may host and administer a portal allowing an external user to manage data, preferences, policies, etc.

The communications interface 140 may be coupled to the processor 120 and allows the processor 120 to communicate with a network 65 to send and receive data from the central apparatus 200. In the present embodiment, the data sources 50 send raw data to the local apparatus 100 via separate communications links as shown in FIG. 2, such as being hard wired to the local apparatus 100. However, in other embodiments, the data sources 50 may also be connected to the network 65 such that the communications interface 140 or another application specific communication interface (not shown) is also configured to receive the raw data from the data sources 50. The manner by which the communications interface 140 connects to the network 65 is not limited and may include a universal serial bus (USB) port, a serial port, a parallel port, a wired network adaptor, a wireless network adaptor, such as a WIFI adaptor or an adaptor for a proprietary network, or similar.

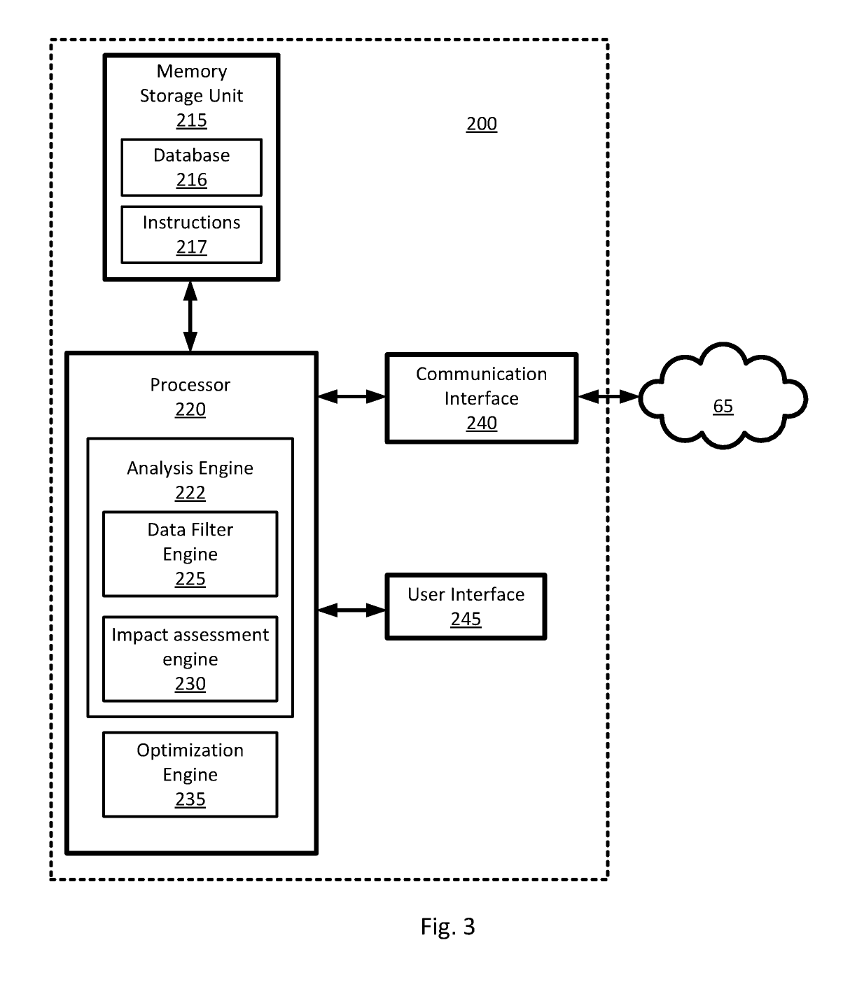

Referring to FIG. 3, a schematic diagram of components of the central apparatus 200 is shown in greater detail. It is to be appreciated by a person of skill in the art with the benefit of this description that the central apparatus 200 may include additional components, such as various additional interfaces and/or displays and input devices to interact with a user or additional processors to handle higher demand for resources. In the present embodiment, the central apparatus 200 includes a memory storage unit 215, a processor 220, a communication interface 240, and an optional user interface 245.

The memory storage unit 215 is coupled to the processor 220 and may include a non-transitory machine-readable storage medium that may be any electronic, magnetic, optical, or other physical storage device. In the present example, the memory storage unit 215 is configured to store a database 216 and instructions 217. The database 216 is for storing various data received at the central apparatus 200 as well as output generated by the central apparatus 200. For example, the database 216 may be configured to receive and store the data from the local apparatus 100. The memory storage unit 215 may also store executable instructions 217 for carrying out functions on the central apparatus 200 described in greater detail below.

The non-transitory machine-readable storage medium may include, for example, random access memory (RAM), electrically-erasable programmable read-only memory (EEPROM), flash memory, a storage drive, an optical disc, and the like. The machine-readable storage medium may be encoded with executable instructions to operate the central apparatus 200 and communicate with the local apparatus 100 and/or other external data sources 50. Although the present embodiment shows the single central apparatus 200 communicating with the one local apparatus 100, it is to be appreciated that in other embodiments, the central apparatus 200 may communicate with more than one local apparatus.

The memory storage unit 215 may also store an operating system that is executable by the processor 220 to provide general functionality to the central apparatus 200, for example, functionality to support various applications such as the user interface 245 to access various features of the central apparatus 200. Examples of operating systems include Windows™ macOS™, iOS™, Android™, Linux™, and Unix™. The memory storage unit 215 may additionally store applications that are executable by the processor 220 to provide specific functionality.

The processor 220 may include a central processing unit (CPU), a microcontroller, a microprocessor, a processing core, a field-programmable gate array (FPGA), or similar. The processor 220 and memory storage unit 215 cooperate to execute instructions 217 to carry out various functions such as the analysis engine 222, which may include a data filter engine 225 and an impact assessment engine 230, and an optimization engine 235. It is to be appreciated by a person of skill in the art that the processor 220 may also be configured to carry out additional functions such as hosting a web apparatus, managing user logins, operating an API gateway, and operating a data aggregation engine.

The communications interface 240 may be coupled to the processor 220 and allow the processor 220 to communicate with the network 65 to send and receive data from the local apparatus 100. The manner by which the communications interface 240 communicates with the network 65 is not limited and may include a universal serial bus (USB) port, a serial port, a parallel port, a wired network adaptor, a wireless network adaptor, or similar.

The user interface 245 is generally configured to receive input from a user and/or generate output in a human perceptible form. The user interface 245 may include one or more user interface devices, such as a display device, a touchscreen, a keyboard, a mouse, a button, a speaker, a microphone, or similar. The user interface 245 may be coupled to the processor 220 to present information to a user in human-perceptible form, such as by rendering a graphical user interface (GUI). The user interface 245 may also receive input from a user through the GUI and provide such user input to the processor 220. For example, the GUI may allow a user to enter commands to analyze raw data received from the local apparatus to generate reports to optimize productivity at a given physical location. In other embodiments, the user interface 245 may be omitted, for example when the central apparatus 200 is a virtual apparatus. In such embodiments, user interaction with the virtual apparatus occurs via communications interface 240 via the network 65.

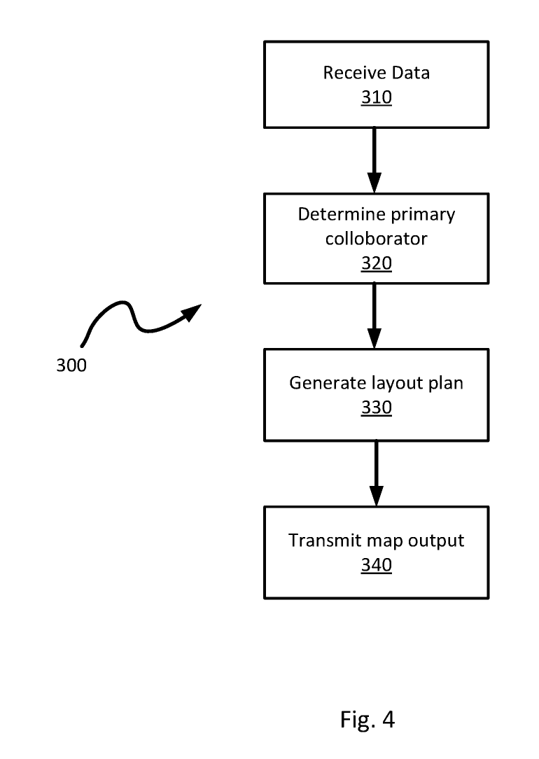

Referring to FIG. 4, a flowchart of a method of collecting data is shown at 300. In order to assist in the explanation of method 300, it will be assumed that method 300 may be performed with the system 10, and in particular by the central apparatus 200. Indeed, the method 300 may be one way in which system 10 may be configured. Furthermore, the following discussion of method 300 may lead to a further understanding of the data sources 50, the local apparatus 100, the central apparatus 200, and their various components. Furthermore, it is to be emphasized, that method 300 need not be performed in the exact sequence as shown, and various blocks may be performed in parallel rather than in sequence, or in a different sequence altogether.

Beginning at block 310, the central apparatus 200 receives data from the local apparatus 100. The data received may represent information about individuals of the organization, such as work habits, locations, and interactions with other individuals of the organization or external parties to the organization. For example, the data received may include building controls data, lights data, occupancy sensor data, and door sensor data. The manner by which the data is received is not particularly limited. In the present embodiment, the central apparatus 200 receives a data file that is uploaded by the local apparatus 100 via an application programming interface. In other embodiments, the central apparatus 200 may receive a stream of real time data via the application programming interface. In further embodiments, the transfer of data may happen via other manners, such as via a file transfer protocol upload or a physical transfer of data via a computer readable storage medium (e.g. a flash drive).

Block 320 comprises determining collaborators within the data received at block 310 using the analysis engine 222. The manner by which the collaborators are determined is not particularly limited. Collaborators are a group of people who are in contact with each other very frequently during the course of performing their duties. In the present embodiment, the collaborators are determined based on the collaboration index value(s) between the two or more individuals, such as between groups of individuals. In this example, a predetermined threshold may be set such that any individuals with a collaboration index value above the threshold value may be identified as a collaborator. The collaboration index value between individuals in an organization may be calculated by analyzing various aspects of the data received from the local apparatus 100. For example, the email habits obtained from email logs, such as from data source 50-1, social interactions, such as those inferred from proximity data from the data source 50-3, and phone records may be used. For example, two or more individuals sharing more emails, time together in a meeting room, and phone calls between their desks or mobile devices may be considered as collaborators. In a simple calculation, the number of communications between two individuals may be used to assign points toward the collaboration index value between the two individuals. In addition, similar communications received by the two individuals, such as a superior providing instruction to a team, may be used to assign points to the two recipients of the email as well. It is to be appreciated that the number of points per communication may be weighted depending on the type of communication.

In the present embodiment, a collaborator is defined as an individual that another individual has interacted within a predetermined time range. The time range is not limited and can be varied depending on the application and the amount of data that is analyzed. A group of collaborators in this embodiment is defined as the group of the fewest number of collaborators that make up 75% of an individual's interactions. The interactions are not limited to any particular form of communication and may involve an aggregate of all interactions, such as email, proximity, and instant messaging. In other embodiments, the definition of collaborator may involve a percentage higher or lower than 75% and/or a varied definition to include or exclude types of interactions that are considered.

It is to be appreciated by a person of skill in the art with the benefit of this description that the data received at the analysis engine 222 from the local apparatus 100 may be filtered or cleansed prior to analysis by the impact assessment engine 230. Accordingly, the data received from the local apparatus 100 may be directed to the data filter engine 225 for cleaning prior to analysis. It is to be appreciated that in the course of normal human interaction, people have a tendency to engage in communications that may not be relevant to the organization. For example, individuals of the organization may engage in small talk and send multiple messages and/or emails regarding non-work related issues such as “small talk”. Accordingly, simply counting emails between individuals of an organization may provide inaccurate results, such as friends with no professional relationship within the organization being identified as collaborators.

The manner by which the data is filtered by the data filter engine 225 is not particularly limited. In an example, the data filter engine 225 may identify irrelevant data in the data, such as data associated with activities unrelated to the organization, such as personal communications. In another example, the data filter engine 225 may identify irrelevant data as any data that is not associated with activities related to the organization. The data filter engine 225 may then discard the irrelevant data since such data may not be associated with any matters or issues relating to the business of the organization. For example, emails may be filtered to remove machine generated emails, which may result merely from an individual being on a distribution list either voluntarily or involuntarily such that the fact that two individuals being on the list may not indicate a level of collaboration. As another example, personal emails, machine generated emails, or emails sent to multiple parties, may be identified using pattern recognition algorithms and removed from consideration by the impact assessment engine 230.

Next, block 330 comprises generating a layout plan or placement map and collaboration index values using the optimization engine 235 to improve efficiency of communications within the organization. In the present embodiment, the layout plan may represent a seating arrangement of physical locations of the individuals of the organization and based on their collaboration index value with other individuals. For example, individuals determined to be collaborators may be placed in close proximity to each other. The seating arrangement may be within a suite of an office tower or spread across multiple buildings and locations for larger corporations. For example, if the desired outcome of a space, such as a floor of an office building, is to have 75 percent be collaborators, the optimization engine 235 selects an appropriate mix of individuals to meet this target. It is to be appreciated that the percentage may be varied and be higher or lower. In addition, in some examples, it may also be desirable to separate collaborators as well to promote new interactions.

It is to be appreciated that the exact target and the manner by which the target is determined is not particularly limited. For example, the target mix of individuals may be based on empirical evidence that serves as a predictor of traffic flow within a physical location as well as the likelihood of interactions with individuals who are not collaborators. It is to be appreciated by a person of skill in the art with the benefit of this description that grouping all the collaborators together results in the generation of silos within the organization where individuals cease to communicate with others outside of the silo. However, have too few collaborators placed in a physical location reduces the number of interactions between the collaborators resulting in an overall decrease in efficiency for the organization. In some embodiments, a good layout plan may include a percentage of collaborators in the vicinity along with others where business logic dictates that there may be reason for the individuals to collaborate. Accordingly, this provides the opportunity to create net new connections and clusters.

Block 340 comprises transmitting the layout plan generated at block 330 back to the local apparatus 100. The manner by which the layout plan is transmitted is not particularly limited and may include the same ways by which data was received in block 310.

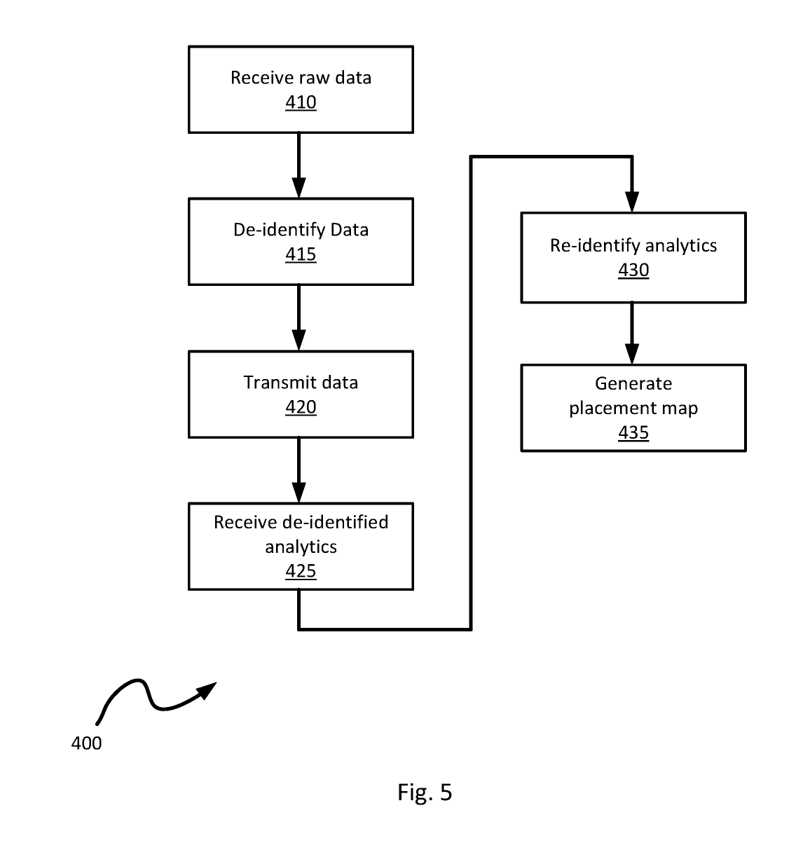

Referring to FIG. 5, a flowchart of another method of collecting data is shown at 400. In order to assist in the explanation of method 400, it will be assumed that method 400 may be performed with the system 10, and in particular by the local apparatus 100. Indeed, the method 400 may be one way in which system 10 may be configured. Furthermore, the following discussion of method 400 may lead to a further understanding of the data sources 50, the local apparatus 100, the central apparatus 200, and their various components. Furthermore, it is to be emphasized, that method 400 need not be performed in the exact sequence as shown, and various blocks may be performed in parallel rather than in sequence, or in a different sequence altogether.

Beginning at block 410, the data collection engine 125 receives raw data from the data sources 50. The raw data received represents information about individuals of the organization, such as work habits, locations, and interactions with other individuals of the organization or external parties to the organization as observed by the data source. The manner by which the raw data is collected is not particularly limited and the type of data collected is also not particularly limited. For example, the raw data collected may include information about individuals of the organization such as the individual's primary physical location (e.g. building, floor, zone, and/or room identifiers), the individual's position within the organization (e.g. manager, supervisor, director, and/or executive), and the individual's title and/or department as wells as the individual's supervisor and/or direct reports.

Block 415 comprises de-identifying the raw data using the de-identification engine 130 to generate de-identified data. The de-identified data removes confidential information, which may include personal information, from the raw data, but maintains all other information. For example, if the raw data includes a plurality of emails, each email in the raw data may typically include the names of the sender and recipient(s) of the email, a subject line, and an email body with content. In the present embodiment, the de-identification engine 130 uses an indexing key to replace the names of individuals or parties in the email (or any form of identifier in data coming out of any application) with an index value of another anonymous identifier that may be generic identifier, or a sequential serial number. Similarly, the content of the subject and the body of the email may be classified using various means, for example, with machine learning techniques such as neural networks or support vector machines.

In the present embodiment, MD5 hashes of both the local and domain parts of each email address is generated. A “salt” is appended to each string to ensure uniqueness among customers. Email subject lines are also hashed after removing “Re:”, “RE:”, “Fwd:” and similar prefixes. In other embodiments, hashing with SHA, or encrypting with AES or RSA (using passwords or public/private key pairs) may be substituted. In further embodiments, a sequential index may be used where a local database is used for reference as the anonymous identifier.

It is to be appreciated that the performance of block 415 need not necessarily happen on the local apparatus 100. In other embodiments, the de-identification engine 130 may be moved to an external resource, such as another apparatus (not shown) or a third party provider.

Block 420 comprises transmitting the de-identified data securely from the local apparatus 100 to the central apparatus 200. It is to be appreciated by a person of skill in the art with the benefit of this description that since the data is de-identified, the central apparatus 200 receives less sensitive information. Accordingly, in embodiments where the local apparatus 100 is subject to strict security requirements, the same requirements may not be necessary at the central apparatus 200, which may be operated by a service provider separate of the operator of the local apparatus 100. Once the de-identified data is transmitted to the central apparatus 200, the method 300 can be executed to produce de-identified analytics, such as a layout plan from the central apparatus 200 with identifiers based on the index key which is not in the control or possession of the central apparatus 200. Accordingly, even though a layout plan may be generated by the method 300, certain information in the raw data may remain confidential, such as personal information, since the identifiers used in the de-identified analytics cannot be traced back to an individual of the organization without the index key. The de-identified analytics is then received at the local apparatus 100 from the central apparatus 200 at block 425.

Block 430 comprises re-identifying the de-identified analytics with the re-identification engine 135 using the index key originally used to de-identify the raw data at block 415. Upon re-identification of the analytics received at block 425, a placement map is generated at block 435 based on the layout plan, which includes the names of the individuals and other confidential information.

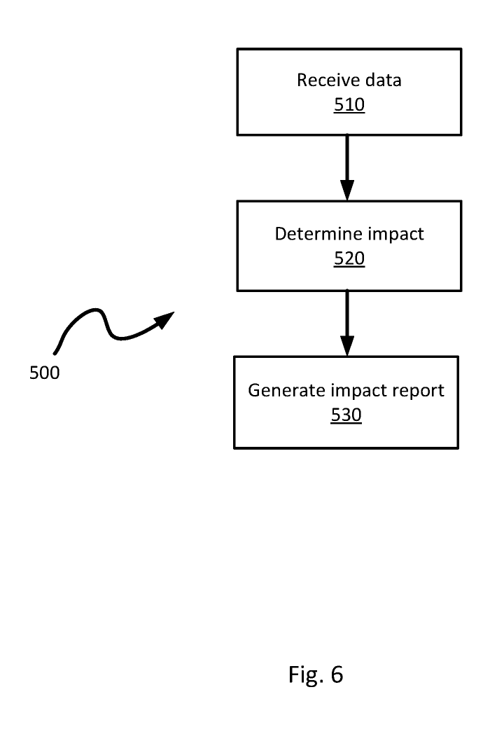

Referring to FIG. 6, a flowchart of another method of collecting data is shown at 500. In order to assist in the explanation of method 500, it will be assumed that method 500 may be performed with the system 10, and in particular by the central apparatus 200. Indeed, the method 500 may be one way in which system 10 may be configured. Other embodiments may involve carrying out a portion or all of the method 500 on the local apparatus. Furthermore, the following discussion of method 500 may lead to a further understanding of the data sources 50, the local apparatus 100, the central apparatus 200, and their various components. Furthermore, it is to be emphasized, that method 500 need not be performed in the exact sequence as shown, and various blocks may be performed in parallel rather than in sequence, or in a different sequence altogether.

Beginning at block 510, the central apparatus 200 receives data from the local apparatus 100 representing a request for an impact report of a change. The change is not particularly limited and can be a change in physical desk spaces due to a renovation or change in personnel, such as a retirement or promotion. The data received represents information about individuals of the organization, such as work habits, locations, and interactions with other individuals of the organization or external parties to the organization. In the present embodiment, the data received is de-identified data. In other embodiments, the data received may not have been cleaned and the raw data may be received. The manner by which the data is received is not particularly limited. In the present embodiment, the central apparatus 200 receives a data file that is uploaded by the local apparatus 100 via an application programming interface. In other embodiments, the central apparatus 200 may receive a stream of real time data via the application programming interface. In further embodiments, the transfer of data may happen via other manners, such as via a file transfer protocol upload or a physical transfer of data via a computer readable storage medium (e.g. a flash drive).

Block 520 comprises determining an impact on productivity of the raw data compared with a baseline measure of productivity. The manner by which the impact is determined is not particularly limited and may involve consideration of various factors and data collected from the data sources 50. For example, the percentage of collaborators within a physical location may provide an indication of productivity.

Next, block 530 comprises generating an impact report using the optimization engine 235. In the present embodiment, the impact report provides an estimated change in productivity based on the results of block 520. It is to be appreciated that the impact report may be presented in multiple formats. For example, the report may be presented in a dashboard with measurements and collaboration index values which a user can view or manipulate to customize a representation.

It is to be appreciated that several variations are contemplated. For example, it is to be appreciated by a person of skill in the art with the benefit of this description that the central apparatus 200 may also be used to analyze clusters of individuals instead of individual team members. For example, clusters may be identified based on the data from the data sources 50 and the members in the cluster can be evaluated by the strength of each member in the cluster using the methods described above. Accordingly, the central apparatus 200 can be used to identify and assign efficient teams within an organization. Alternatively, the analysis can also be used to analyze management styles within a team environment.

Furthermore, the analysis carried out by the central apparatus 200 need not be only applied to individuals of the organization. It is to be appreciated that the analysis can be applied to external parties such as a contractor to evaluate the efficiency of the contractor. Alternatively, the analysis can also be applied to customers and clients to evaluate a relationship and identify areas where additional client relationship building is recommended.

As another example of a variation, the central apparatus 200 may also be configured to provide benchmarking of teams, departments, groups, members within an organization, and multiple organizations against each other, such as the strength of a relationship between organizations. Furthermore, the central apparatus 200 may be used to evaluate leaders within the organization and/or identify leaders based on the amount of influence the individual has on others around that individual.

The specific embodiments described in the preceding sections have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. An apparatus to improve productivity at an organization, the apparatus comprising:
a communication interface to receive processed data collected at the organization, wherein the processed data is based on data from a plurality of data sources;
a memory storage unit to store the processed data;
an analysis engine in communication with the memory storage unit, wherein the analysis engine is to analyze the processed data to determine a collaboration index value between a first individual at the organization and a second individual at the organization; and
an optimization engine to generate a layout plan based on the collaboration index value.

2. The apparatus of claim 1, wherein the processed data is de-identified to remove confidential information, and wherein the processed data includes an anonymous identifier.

3. The apparatus of claim 2, wherein the anonymous identifier is to associate a first portion of the processed data with the first individual and to associate a second portion of the processed data with the second individual.

4. The apparatus of claim 1, wherein the analysis engine includes a data filter engine to cleanse the processed data.

5. The apparatus of claim 4, wherein the data filter engine identifies irrelevant data in the processed data and discards the irrelevant data, wherein the irrelevant data is associated with activities unrelated to the organization.

6. The apparatus of claim 5, wherein the irrelevant data includes personal communications.

7. The apparatus of claim 1, wherein the analysis engine includes an impact assessment engine to calculate the collaboration index value based on the processed data.

8. The apparatus of claim 7, wherein the processed data includes communications between the first individual and the second individual in the organization, the impact assessment engine to assign points between the first individual and the second individual based on a number of communications, wherein the points are used to determine the collaboration index value.

9. The apparatus of claim 7, wherein analysis engine is to identify the first individual and the second individual as collaborators if the collaboration index value is above a predetermined threshold.

10. The apparatus of claim 9, wherein optimization engine generates places collaborators in proximity in the layout plan to improve efficiency of communications between the collaborators.

11. A method of improving productivity at an organization, the method comprising:
receiving processed data collected at the organization via a communication interface, wherein the processed data is based on data from a plurality of data sources;
storing the processed data in a memory storage unit;
analyzing the processed data to determine a collaboration index value between a first individual and a second individual; and
generating a layout plan based on the collaboration index value.

12. The method of claim 11, further comprising cleansing the processed data.

13. The method of claim 12, wherein cleansing the processed data comprises identifying irrelevant data in the processed data and discarding the irrelevant data, wherein the irrelevant data is associated with activities unrelated to the organization.

14. The method of claim 13, wherein the irrelevant data includes personal communications.

15. The method of claim 11, wherein the processed data includes communications between the first individual and the second individual in the organization.

16. The method of claim 15, further comprising assigning points between the first individual and the second individual based on a number of the communications, wherein the points are used to determine the collaboration index value.

17. The method of claim 11, further comprising identifying the first individual and the second individual as collaborators if the collaboration index value is above a predetermined threshold.

18. The method of claim 17, wherein generating the layout plan comprises placing collaborators in proximity to improve efficiency of communications between the collaborators.

19. A non-transitory machine-readable storage medium encoded with instructions executable by a processor, the non-transitory machine-readable storage medium comprising:
instructions to receive processed data collected at an organization via a communication interface, wherein the processed data is based on data from a plurality of data sources;
instructions to store the processed data in a memory storage unit;
instructions to analyze the processed data to determine a collaboration index value between a first individual and a second individual; and
instructions to generate a layout plan based on the collaboration index value.

20. The non-transitory machine-readable storage medium of claim 19, further comprising:
instructions to identify the first individual and the second individual as collaborators if the collaboration index value is above a predetermined threshold; and
instructions to place collaborators in proximity in the layout plan to improve efficiency of communications between the collaborators.
